(19) United States
(12) Patent Application Publication
(10) Pub. No.: US 2017/0027311 A1
(43) Pub. Date: Feb. 2, 2017

(54) Garment attachable cell phone holder

(71) Applicant: Stephanie Jane DeDonatis, Hershey, PA (US)

(72) Inventor: Stephanie Jane DeDonatis, Hershey, PA (US)

(21) Appl. No.: 14/756,053

(22) Filed: Jul. 27, 2015

(51) Int. Cl. A45F 5/02; H04B 1/3888; A45C 11/00

(52) U.S. Cl. CPC A45F 5/02; A45C 11/00; H04B 1/3888; A45C 2011/002

(57) ABSTRACT

An attachable holder for securing a cell phone and other small objects inside a strap-utilizing garment that:
secures the cell phone and other small objects between the body of the wearer and the wearer's garment;
can be easily used with a variety of strap-utilizing garments; and
can be repositioned vertically in relation to the strap of the garment for comfort.

### CROSS REFERENCE TO RELATED APPLICATION

This application is related to U.S. Provisional Application No. 62/033,285, filed Aug. 8, 2014, and claims priority thereto. Application No. 62/033,285 is hereby incorporated in its entirety.

### FIELD OF THE INVENTION

This invention relates to a garment attachable pocket for securing objects, specifically small objects.

### BACKGROUND OF THE INVENTION

Women have a need to carry valuables on their person. Cell phones, credit cards, and driver's licenses are all indispensable items in modern society. A purse, however, is not always practical to use. A purse cannot be worn comfortably while a woman is engaged in aerobic sports, and is inconvenient while engaged in other activities. Furthermore, as it is worn on the exterior of the body, a purse can easily be stolen from its wearer.

There have been attempts to remedy these problems by having women utilize storage pockets attached to the woman's clothing. However, these pockets are worn at inconvenient locations on the person, such as the waist or under the arm, and thus do not provide easy access to the pocket's contents. Furthermore, these pockets do not allow the wearer to reposition it for enhanced comfortability.

### SUMMARY OF THE INVENTION

The present invention is a pocket that can store small items, like a cell phone, on the interior of a woman's brasserie, shirt, or other garment. The pocket is attachable to the strap of a brasserie, shirt or other garment, which allows the wearer to reposition the pocket up and down the length of the brasserie, shirt, or other garment strap in order to enhance comfortability. The pocket also secures items in an enclosed location on the wearer that allows quick and convenient access to the contents inside the pocket. The pocket, because of its discreet location, is a more hidden option than a purse that protects the pocket's contents from potential muggers.

### BRIEF DESCRIPTION OF THE DRAWINGS

FIG. 1 shows a frontal view of a pocket with a flap opened;

FIG. 2 shows a rear view of a pocket with a flap opened;

FIG. 3 shows a frontal view of a pocket with a flap closed; and

FIG. 4 shows a frontal view of a pocket with a radiation-resistant fabric or material.

### DETAILED DESCRIPTION OF THE INVENTION

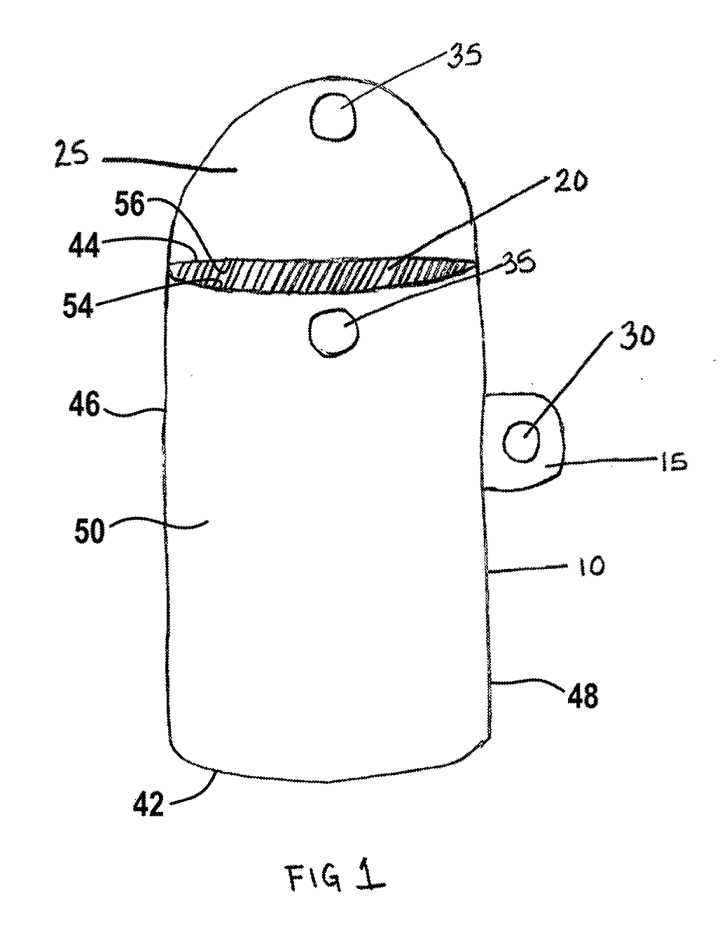

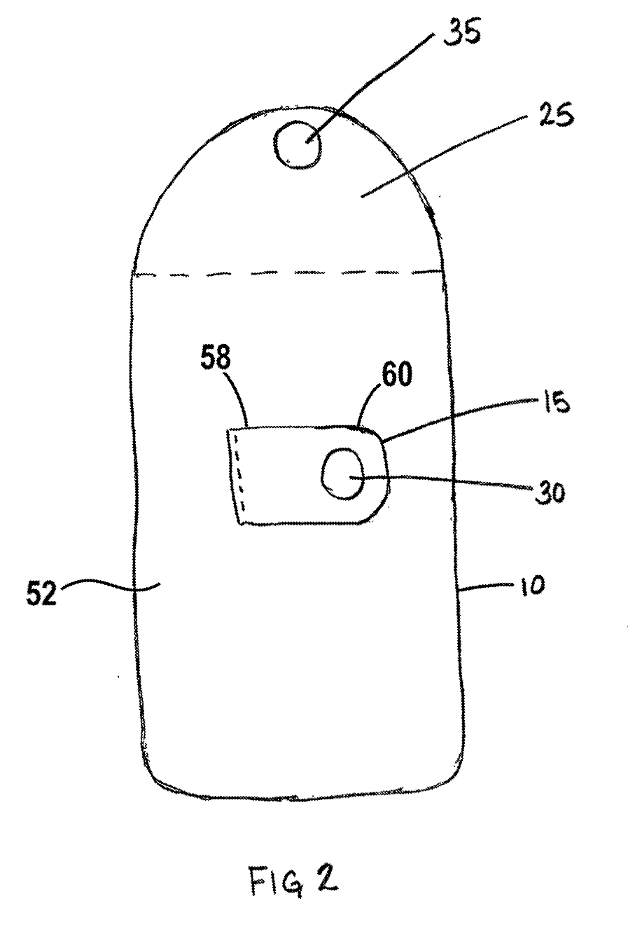

FIG. 1 is an illustration of a first embodiment of the garment attachable cell phone holder of the present invention. Pocket 10 is worn either between a garment and the wearer's body or outside of the garment. The pocket is attached to a garment strap by utilizing first fastener 15. The first fastener can be, but is not limited to: snaps, buttons, Velcro, or a hook. The first fastener is attached to strap 30, and the strap is attached to the pocket. The strap allows the pocket to be repositioned horizontally or vertically in relation to the garment strap for comfortability. The pocket is made of washable material that is comfortable to wear against the skin of the wearer, such as neoprene. The entire pocket is shaped to a standard smart phone shape so that the pocket can hold a smart phone securely in place. The pocket houses cavity 20 where the small items are placed. Flap 25 is attached to the pocket and folds over the cavity to hold the items within the cavity in place. Second fastener 35 ensures the flap stays closed. The second fastener can be, but is not limited to: buttons, snaps, or Velcro.

FIG. 4 is an illustration of a second embodiment of the garment attachable cell phone holder of the present invention. Radiation-resistant fabric/material 40 is attached to the pocket. The radiation-resistant fabric/material is placed between the wearer and contents in the cavity so that any emitted radiation is blocked from being absorbed by the wearer.

1. A garment attachable cell phone holder, comprising:
a. a pocket, wherein the pocket houses a cavity, the pocket comprising opposite first and second ends spaced apart from one another and first and second peripheral sides spaced apart from one another and extending from the first end of the pocket to the second end of the pocket, the first end of the pocket being closed and the second end of the pocket being open to the cavity, the pocket comprising a front wall on a front side of the pocket and a back wall on a back side of the pocket and the cavity being between the front and back walls, the front and back walls facing one another and extending from the first end of the pocket to the second end of the pocket and extending from the first side of the pocket to the second side of the pocket, the front and back walls having cooperating edges that define the open second end of the pocket;
b. a flap attached to the pocket, the flap extending from the edge of the back wall;
c. a first fastener comprising a first fastener member and a second fastener member releasably fastenable to the first fastener member, the first fastener member secured to the flap and the second fastener member secured to the front wall of the pocket, the flap extending over and closing the open end of the pocket when the first fastening member is fastened to the second fastening member;
d. a strap attached to the pocket, the strap extending from a first end portion secured to the back wall to an opposite second end portion; and
e. a second fastener comprising a third fastener member and a fourth fastener member releasably fastenable to the third fastener member, the third fastener member secured to the strap, the fourth fastener member secured to the back wall, the strap extending along the back wall and cooperatively defining with the back wall a slot disposed between the strap and the back wall when the third fastening member is fastened to the fourth fastening member.

2. The garment attachable cell phone holder of claim 1, further comprising:
f. a radiation-resistant body overlying at least a portion of the cavity.

3. The garment attachable cell phone holder of claim 1 wherein the strap is entirely disposed between the first and second peripheral sides of the pocket when the third fastener member is attached to the fourth fastener member.

4. The garment attachable cell phone holder of claim 1 wherein the pocket is made from neoprene.
